(19) United States
(12) Patent Application Publication
(10) Pub. No.: US 2004/0098360 A1
(43) Pub. Date: May 20, 2004

(54) Customized life portal

(75) Inventors: George B. Witwer, Bluffton, IN (US); Brian V. Mayo, Greenwood, IN (US)

Correspondence Address: WOODARD, EMHARDT, MORIARTY, MCNETT & HENRY LLP, BANK ONE CENTER/TOWER, 111 MONUMENT CIRCLE, SUITE 3700, INDIANAPOLIS, IN, 46204-5137, US

(73) Assignee: Humanizing Technologies, Inc.

(21) Appl. No.: 10/298,182

(22) Filed: Nov. 15, 2002

(51) Int. Cl. G06F 17/30

(52) U.S. Cl. 707/1

(57) ABSTRACT

A user-created life portal for viewing and accessing content on the Internet is described. The platform, referred to as a life portal, is configured by the user to display only content that is of interest to the user, thereby reflecting the personality and life of the user. The content displayed in a life portal is scraped from web sites and is not limited to sites licensed or maintained by the life portal service provider. The content is displayed as a view or a magazine. Views and magazines (content) are stored in life pages. A view is content that is contained in a portlet and is retrieved from a single web site. A magazine is a collection of content, such as article headlines and links, on a particular topic from one or more web sites. All content in a life portal is specifically tailored to meet the targeted interests and preferences of the user and is designed to exclude content not of direct interest to the user.

### BACKGROUND OF THE INVENTION

1. Field of the Invention

The present invention relates generally to Internet application software and web site configuration. More specifically, it relates to a personal portal web site configuration and to modes of retrieving and displaying content to users.

2. Discussion of Related Art

There are presently numerous ways to create custom or personal homepages at high-traffic portals on the Internet as well as at lesser known web sites. For example, conventional personal portals designed from the “top down,” such as “MyYahoo” and “My Excite,” among many other similar user tools and options at other web sites and portals have been available for many years.

However, despite their availability for the last several years, the use of personal home pages at widely used portals has not seen widespread acceptance among a vast majority of Internet users. This is a result, in large degree, to the relative complexity and sophistication required to configure, program, and maintain personal and custom web pages. Moreover, even after overcoming the initial barrier to creating and configuring personal web pages, many users have found that the sites they have created are, indeed, not as personal or customized as they were expecting. Many of them continue having difficulty retrieving and displaying content that is truly targeted to their interests, preferences, and priorities. Thus, for many users, tools for creating personal web sites do not satisfactorily meet their expectations or needs. For example, although a user can create a personal homepage at a portal or portal-type web site, the user often still must pass through several web pages to reach content of interest to the user. In one scenario, a user wanting to check local high school sport scores or check scheduling information for community events may not be able to do so if going through present personal web sites, or a user may have to view multiple pages before reaching the page with the relevant content. As such, the level of customization of user home sites at many portals is not satisfactory.

Furthermore, the content (e.g., local news, sports, weather, specialized subjects, and so on) may not be retrievable from the portal or ISP hosting the user's personal web site. The range of content available may be limited to the content created or hosted by the portal or made available to the portal (e.g., licensed by the portal or ISP), or may otherwise be from a limited range of sources. Typically, the portals and ISPs providing the personalized portal service are content aggregators. However, the amount of content that can be aggregated is necessarily limited because most of the content on the Internet is not available for syndication and, therefore, cannot be collected by third-parties, such as portals. Consequently, content aggregators cannot offer the breadth of content needed to fully meet the content needs of all potential users, each of whom will likely have unique, wide-ranging interests. The sources available to the portal are limited to sources licensed for use by the portal and may not have the content the user wants, thereby restricting the level of customization of the personal web pages.

Furthermore, portals using present meta-browsing technology for providing content in personal portals have significant shortcomings with respect to displaying various types of content. Meta-browsing technology generally fails to address conflicts and errors that arise when manipulating various types of content and how web sites implement or handle content, such as HTML and javascript. This limits the portals ability to provide content relating to various aspects of a user's life. Furthermore, present meta-browsing technology fails to allow users to see the entire range of content from a web page. For example, present meta-browsers only allow users to see content limited to a single table and does not enable the user to see complete portions of a web page. Present technology also often fails to maintain and consistently display tables in views via present meta-browsers. Additionally, meta-browsing technology is not efficient at locating content that a user will likely want to follow in order to stay current on the user's interests. Finally, meta-browsing technology is often difficult and cumbersome to use, making it inaccessible to the majority of non-technical users.

What is needed is a truly customized, personal web site that can be created and maintained in an efficient and intuitive manner. It would be desirable to allow a user to create a truly personal web site or portal that, at a high level, reflects the user's life and who that person is; that is, web pages that present the user with content, such as views into user-selected web sites and topical magazines, that are of direct interest to the user. Such a personal portal should be a unique collection of content reflecting each user's individual collection of interests without significant limitations, i.e., a portal customized for a user from the “bottom up.” Furthermore, it would be desirable to allow a user to create a user portal that presents only content in which the user is interested and does so in a format and via a user interface that facilitates accessing and viewing the information. The user should not be restricted with respect to the range of the content from a web site that can be viewed at the personal portal. The user should be able to see content from multiple tables on a web page or only a portion of a table. It would also be desirable if content for the portal is retrieved from a wide range of sites on the Internet and not be limited to a “walled garden.” The process of creating such a portal should be streamlined and intuitive making it accessible and inviting to non-technical or non-computer savvy users.

### SUMMARY OF THE INVENTION

In one aspect of the present invention, a user life portal on the Internet built from the bottom up is described. The life portal has at least one life page, at least one view contained within the life page wherein the view is content relating to a user's interest. In another aspect of the present invention, the user life portal, a life page contains at least one magazine wherein the magazine contains text and links directing a user to articles relating to a user's interest. Through a high degree of customization of content comprising views and magazines contained in life pages, a life portal closely matches the unique interests and specific needs of a user.

In one embodiment of the present invention, a user can create a pixel view which is any portion of content chosen by a user from a web page scraped from a web site. In another embodiment, a user can create a parsed view which is content consisting of a table from a web page scraped from a web site. In yet another embodiment of the present invention, a user can create a magazine containing text, such as headlines or titles of articles and links to those articles, on a specific topic selected by the user. Magazine content is derived from the life portal service provider determining what themes are present in an article, clustering the themes so that they are logically indexed, and storing the themes and links to the articles in the service provider database.

These content, whether in the form of views, magazines, or other constructs, are contained in portlets which, generally, are contained in life pages. Content can also be stored in a container referred to as a persistence panel in a life portal. Content is scraped or retrieved from virtually any web site on the Internet and is not restricted to web sites having a previous relationship with the service provider, such as a licensing agreement or contract, nor is it restricted to content created, produced, or commissioned by the service provider. In another embodiment of the present invention, the life portal service provider offers a user pre-created views and magazines on topics in which the service provider believes its users may have an interest or which the service provider believes contains high-quality content.

### BRIEF DESCRIPTION OF THE DRAWINGS

The invention will be better understood by reference to the following description taken in conjunction with the accompanying drawings in which:

FIG. 1 is a hierarchical diagram showing a structure of a life portal in accordance with one embodiment of the present invention.

FIG. 2 is diagram showing relationships among a life portal service provider, a life portal user, and third-party web sites providing content for the life portal.

FIG. 3 is an overview flow diagram of a process of creating a custom life portal from a standard life portal in accordance with one embodiment of the present invention.

FIG. 4 is a screen display of a life portal and life page showing a magazine and view in accordance with one embodiment of the present invention.

FIG. 5A and 5B are screen displays of a life portal showing a menu of actions a user can perform on views, magazines, and life page in accordance with one embodiment of the present invention.

### DETAILED DESCRIPTION

Reference will now be made in detail to a preferred embodiment of the invention. An example of the preferred embodiment is illustrated in the accompanying drawings. While the invention will be described in conjunction with a preferred embodiment, it will be understood that it is not intended to limit the invention to one preferred embodiment. To the contrary, it is intended to cover alternatives, modifications, and equivalents as may be included within the spirit and scope of the invention as defined by the appended claims.

The present invention encompasses a user-created portal on the Internet referred to herein as a life portal. A life portal contains one or more storage containers referred to as life pages. A life page is a content storage area which, in turn, holds information in the form of magazines and views, both of which are content specifically compiled for a user. Magazines and views are stored in portlets. Thus, a life page may have multiple portlets for storing content. The life portal of the present invention reflects the life of a user; it displays content of specific, user-defined interest to selected aspects of the user's life. A life portal reflects the wide ranging interests of a user limited only by the content accessible on the Internet and other public and private networks, such as Intranets, virtual private networks, and so on. In the described embodiment, the Internet and browsers are used for illustration, however, other networks, data sources, and user interfaces can be applied to the concepts and implementations described herein for the present invention.

Methods and systems of creating and using a life portal and the components comprising a life portal are described in the various figures. In a preferred embodiment of the present invention, a user is initially presented with a standard life portal. A standard life portal is customized by a user to display content, as views and magazines, most of which is retrieved from the Internet.

In another preferred embodiment, the user is presented with an empty life portal from where a user can begin creating life pages and a persistence panel, described below. The content is displayed as views and magazines which are stored in life pages classified by topics chosen by the user. In another preferred embodiment, the user is taken through a series of queries when initially creating a life portal. Based on replies to the queries, the new user is presented with pre-created life pages that contain views and magazines that may be of interest to the user. It also gives the user an opportunity to get familiar with using and manipulating life pages, views, and magazines. The replies to the queries determine which categories or topics are presented to the user in the form of life pages. For example, if the user's interest lie more in finance and business rather than entertainment or sports, the pre-created life pages selected will reflect these broad categories which the user can further customize. Of course, the user can, and likely will, create his own life pages, views, and magazines that uniquely reflect aspects of the user's life.

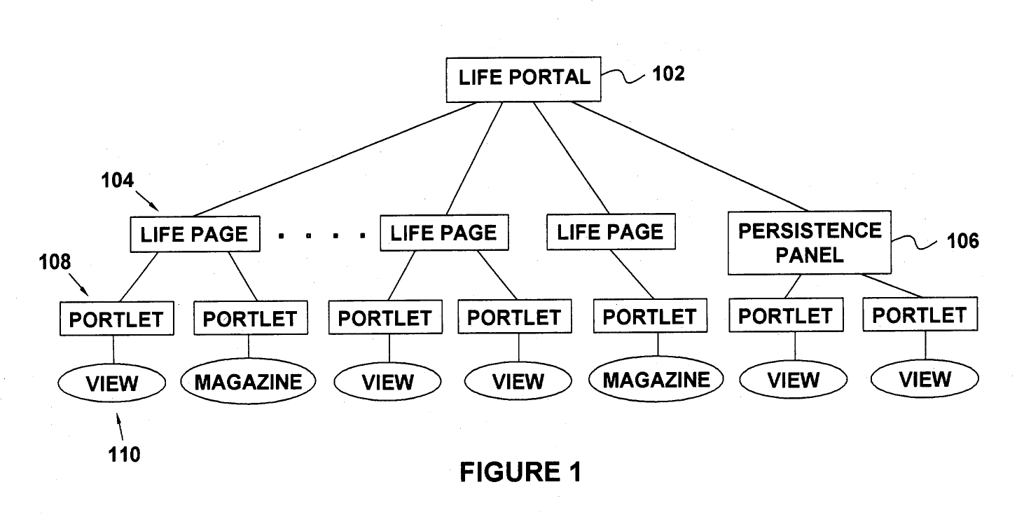

A hierarchy of components comprising a life portal is shown in FIG. 1A. At the root of the hierarchy is a life portal 102 on the Internet viewable through a browser. Below the life portal are one or more life pages 104. There may also be a persistence panel 106, a special type of container storing content that the user views often or would like to see at all times while in the life portal and, therefore, is not ideally suited for storing in a life page. A persistence panel contains views and/or magazines that are always displayed on a life portal. Below each life page are portlets 108. Contained in a portlet is content 110, at the bottom of the hierarchy, specifically, views and magazines. The views and magazines can be either pre-created or uniquely created by a user.

The life portal of the present invention has a user interface designed to enable a user to navigate through the portal and create and retrieve content in an efficient and intuitive manner. In a described embodiment, for example, a life page is represented by a tab icon, resembling a folder tab. In other preferred embodiments other graphical icons or designs, such as buttons or menu bars can be used.

A life portal engine and overall administration and operation of life portals are under control of a life portal service provider. As described in greater detail below, content from the Internet is scraped or fetched from a wide variety of web sites, theoretically any web site on the Internet accessible with a browser. In the described embodiment, the life portal service provider servers store text utilized for indexing magazine content. Techniques for scraping or collecting content from web sites are known to persons of ordinary skill in the field of Internet application programming. The service provider is not a conventional content aggregator that is limited or restricted to scraping content from only selected sites or sites having a relationship with the service provider; that is, content in a life portal is not restricted to so-called “walled gardens.”

A user modifies a life portal primarily by creating, deleting, and modifying life pages, views, and magazines. A user can change the criteria used by life portal application software to fetch content from the service provider's databases, thereby changing the views and magazines in the life pages and persistence panel.

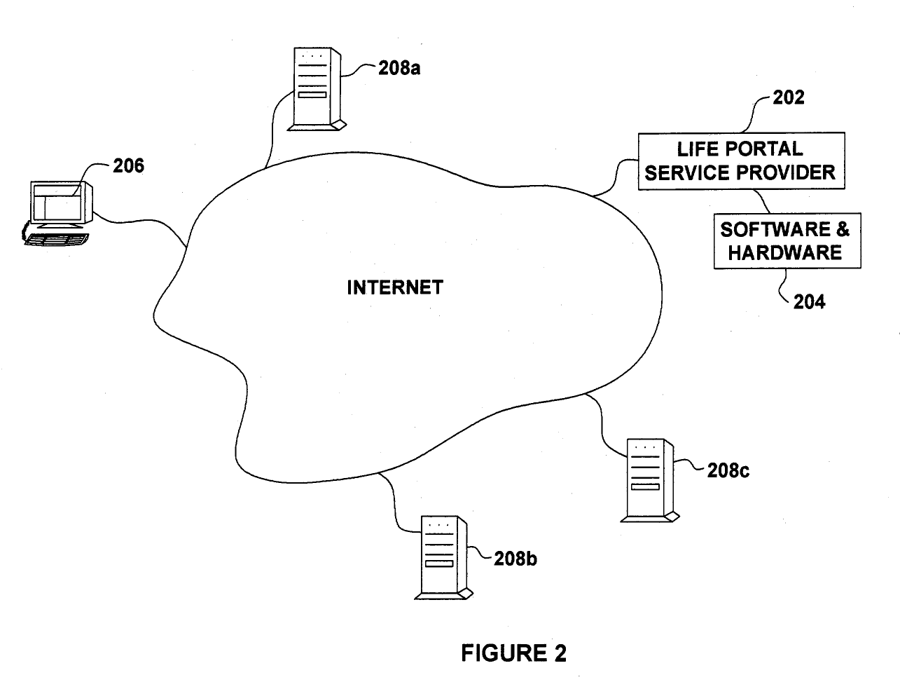

The relationships among the service provider, a life portal user, and web sites providing content on the Internet are shown in FIG. 2. A life portal service provider 202 maintains software and hardware components 204 that power the creation and upkeep of numerous life portals, such as a life portal 206. For example, one of the software components 204 is a database containing content, such as news articles and other types of text-based content, scraped from web sites and themed by the life portal service provider using techniques known in the field. As described in greater detail below, the themed content is used to create magazines. The range of web sites, such as sites 208a, 208b, and 208c, from which content is scraped is unlimited insofar that the service provider is permitted to access the site and retrieve content.

Content is retrieved from the third-party web sites and themed at the life portal service provider 204 for compiling magazines. After the content is themed, it is distributed to life portal 206. The service provider does not place any self-imposed restrictions on which sites it can access to scrape content. Thus, the service provider is not limited to content hosted, licensed, or created by the provider. Generally, the service provider will select which web sites are accessed. The user can request that the service provider access specific sites to scrape content that the user has a specific interest in. The service provider will consider the request and make a decision as to whether to access the sites. In another preferred embodiment, the service provider may place reasonable restrictions on which sites it will access, such as refusing to access to pornographic sites or sites that contain content not legally obtained by the sites, such as pirated material.

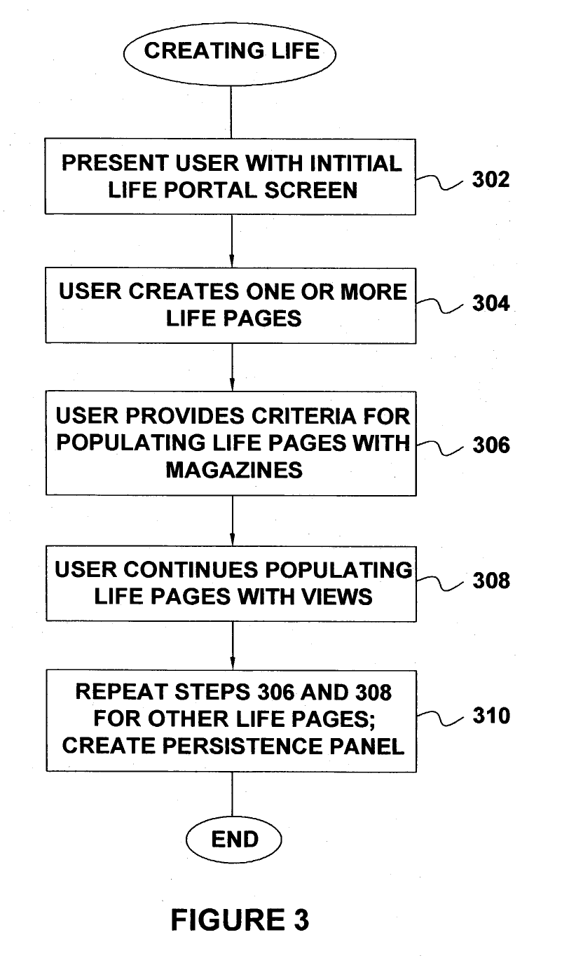

FIG. 3 is an overview flow diagram of a process of creating a personal life portal in accordance with one embodiment of the present invention. Before the process begins, a user goes to the life portal service provider web site on the Internet. In one scenario, the user's Internet service provider provides a link to the life portal service provider registration page. For example, the life portal may be a tool or feature offered by an ISP to its subscribers and is powered by the life portal service provider. In any case, once at the registration page, the user creates a password and completes other administrative steps as required by the ISP or life portal service provider.

At step 302 the user begins the process of creating a customized life portal. One of the primary goals of the present invention is to allow the user to create a portal that closely reflects various aspects of the user's life. Specifically, at step 302 the user is presented with a blank life portal screen. In other preferred embodiments, the user responds to queries which are examined by the life portal service provider so it may provide the user with pre-created life pages. In the described embodiment, the content in the pre-created life pages include sites that the service provider believes can provide high quality content or content that will likely be of interest to many of its users.

The present invention enables a user to build a life portal dynamically from the bottom-up; that is, the user builds a unique and customized life portal to match her interests and specific needs by retrieving content from the service provider database and that has been themed for inclusion in magazines and content from an unlimited range of web sites on the Internet for views. The user creates a truly unique portal that is closely tailored for her and reflects the various aspects of her life.

Content is scraped from a wide range of web sites by a portal engine and themed and clustered based on the subject matter of the content. The portal engine scrapes can scrape any web site accessible through a browser or any other type of user interface capable of accessing content on the Internet or public or private network. In the described embodiment, the portal engine scrapes web sites and places the scraped content in document roots or buckets. In other preferred embodiments, various types of data formats or data in other types of markup languages from data sources besides the Internet can be retrieved. The content scraped is from pages at the sites that have content on them at is updated regularly. Once a site is scraped initially, subsequent content scrapes are of articles and content that have been updated, for example, daily or weekly. Methods for scraping and retrieving content from web sites are known in the field of Internet application programming.

After the content has been retrieved, the life portal service provider scans the content and assigns themes to the content. For example, dominant phrases, words and so on are identified and the portal engine attaches one or more themes to the content. The key themes are extracted and stored with the content in a database. Thus, whenever content is pulled from the database, the content themes are pulled as well. This is done using algorithms known in the field of computer programming. After content is themed and before the content and the theme identifiers are stored in the database, the content is clustered with existing content based on the content's themes. Newly scraped content may have more than one theme in which case a link to the content resides in more than one location in the clustering hierarchy. New content is clustered with existing content using algorithms known in the field of computer programming. By clustering content themes, the portal engine can retrieve all content relevant to a particular topic. This process is used in compiling articles for magazines.

The life portal service provider can also create magazines for its users. A pre-created magazine is created in the same way as regular magazines except the service provider first identifies each magazine source or web site. For example, a pre-created magazine on professional basketball may have as sources NBA.com, the NBA page of the ESPN.com web site, and the NBA page of the FoxNews.com web site. These three sources, among others, are content sources that the service provider can use to create a magazine which it makes available to life portal users.

A user has the ability to create views of multiple lesser known sites which provide content that may not be available at many of the major portals and web sites, such as Excite, MSN, or Yahoo. A user can also create magazines containing content on any topic of interest to the user. Magazines contain links to textual content and associated pictures, such as news stories relevant to the topic chosen by the user, and that the service provider has themed. In the described embodiment, a user can also select content from pre-created views and magazines created by the life portal service provider. These pre-created views and magazines contain content that may be of interest to a wide range of users or may be high-quality content that the service provider believes would appeal to its users. In creating a magazine, the user launches a search of the content already scraped, themed, clustered, and indexed by the service provider. The user is not restricted to a so-called “walled garden,” a limited collection of web sites, when retrieving content. The user may also request that specific web sites be scraped for content.

At step 304 the user begins creating life pages. In one preferred embodiment, the user is presented with an empty life page that can be described as a canvass on which a user will configure and arrange content, namely, views and magazines. In another preferred embodiment, the initial life pages are created by selecting categories from a list of pre-defined categories supplied by the service provider or by responding to queries posed by the service provider to efficiently determine the user's interests. The user can assign essentially any name to the life pages. The names are displayed on tabs or other graphical icons or designs. In the described embodiment, the names are always displayed on a life portal regardless of which life page is displayed.

At step 306 the user provides criteria for populating a life page with content. The user can populate life pages with content as desired without significant constraints imposed by the life portal service provider. The content can fall under any topic selected by the user, and may be a specialized or obscure topic. This approach to populating life pages with content reinforces the concept of building of a life portal from the bottom up to uniquely match the interests and priorities of each user.

As noted, one type of content is a magazine. The user selects a life page and creates a magazine on a particular topic presumably falling under the subject matter of the life page. The portal engine compiles the magazine for the user by searching for articles on the topic from the themed content on the life portal service provider content databases. A user can suggest or request that content at those sites be scraped so it is available for inclusion in a magazine. In the described embodiment, the service provider decides which sites will be examined for content to ensure that proscribed content is not accessed from the service provider's databases. The most relevant segments of the content are located at various web sites and aggregated to create a magazine. In any case, headlines of news stories and other types of text articles with hyperlinks from the various sites are combined to create the magazine. Thus, the magazine is highly tailored and unique to the user.

At step 308 the user continues to populate life pages with content by creating views. A view is content from a single web site and allows a user to see a portion of a third-party web site without leaving the user's life portal. In effect, a portion of the third-party web site is a component in the user's life portal and viewable using a meta-browser. Views and magazines are stored in portlets. In the case of views, portlets allow users to see views via a meta-browser, a browser nested within the user's browser used to see content from another web site. In the described embodiment, other types of content or tools, such as video or javascript, can be contained in a portlet.

Once the user creates magazines and/or views for a life page, the process of initially populating a life page with content is complete. The process is then repeated for other life pages at step 310. The user can also create a persistence panel which is always displayed in the life portal regardless of which life page is displayed. The persistence panel can be also be created configuring the life pages.

One of the goals of the present invention is to create a life portal using views and magazines stored in life pages that closely reflect the unique personality, interests, preferences, and so on of a particular user. As such, the life pages, views, and magazines of individual life portals can vary widely. The life portal service provider may also allow the user to modify, to some degree, the look and feel of the life portal. One aspect of a life portal is that it allows a user to see numerous views and magazines from different life pages simultaneously.

In the described embodiment, a user creates life pages as described at step 304 of FIG. 3. A life page can be described as a folder for views and magazines which, from the user's perspective, share a common subject or topic. A life page is given a title by the user, which may be any name desired by the user, a feature that further emphasizes the concept of the life portal reflecting the user's personality, life, and interests.

Once a user has created a life page, for example, a “MOVIES” life page, the next step is to create views and magazines within MOVIES. A life page is essentially a container or folder with a user-selected name and, therefore, has no significance or use if not populated with content. In the described embodiment, content is either a view or a magazine.

Views and magazines are created on topics selected by the user. In the MOVIES life page, the user can create a view that is content from the “Hollywood Reporter” web site, another view that is content from the “Variety” web site, and so on. The user can also create a magazine that contains headlines and links to articles on movies by a particular studio. The articles and text-based content will come from various web sites, thus, a magazine is the appropriate medium for this content.

The user can assign any name to a life page, as well as to views and magazines. A life page can also be pre-created by the service provider and contain pre-created views or magazines. Pre-created life pages, views and magazines are components that the life portal service provider believes may be of interest to many of the life portal users or that the service provider would like to bring to the attention of the users because the content is of particularly high quality. For example, a pre-defined life page named by the life service provider as CURRENT EVENTS may have pre-defined views such as a segment of the CNN web site or a view showing the front page of the Wall Street Journal. Similarly, a life page can have pre-created magazines. A user can decide to keep or delete a pre-defined view or magazine in a life page and add her own views and magazines. A user can also change the name of the life page from CURRENT EVENTS to another name.

In the described embodiment, the user can perform certain functions or actions on views, magazines and life pages. For example, a user can add or delete a view, magazine, or life page. A user can also edit a view, magazine, and life page. Some of the editing functions for a life page include the following: clean-up, save, delete, refresh, and rename. Some of the editing functions for a view include: fix, move, delete, refresh, rename, and set auto refresh rate.

If a web page from which content originates undergoes a change in format or configuration, such as the insertion of a table, the user can execute a fix view operation. When a fix view operation is selected, a new window appears and the user can adjust the view as needed. For example, the user can select a different table or segment from the page or can instruct the engine to use the seventh table instead of the sixth table in a page, and so on. By performing this operation, the life portal engine will adjust how and from where it will retrieve data from the web sites. For example, a table on a web page may have been moved, re-sized, or changed in some manner. Many popular sites reconfigure the layout of their pages often.

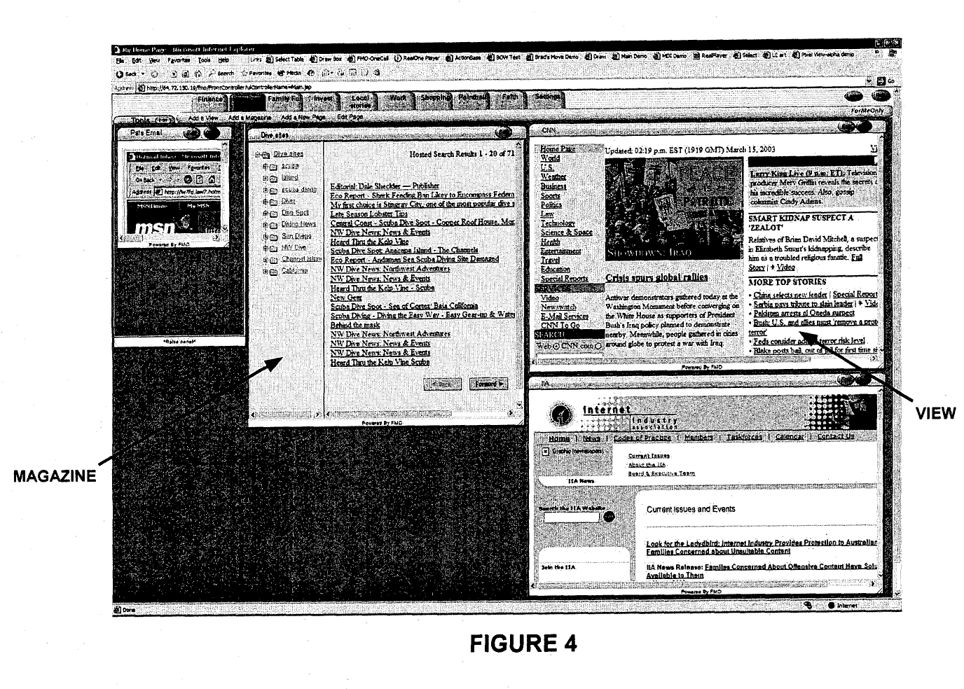

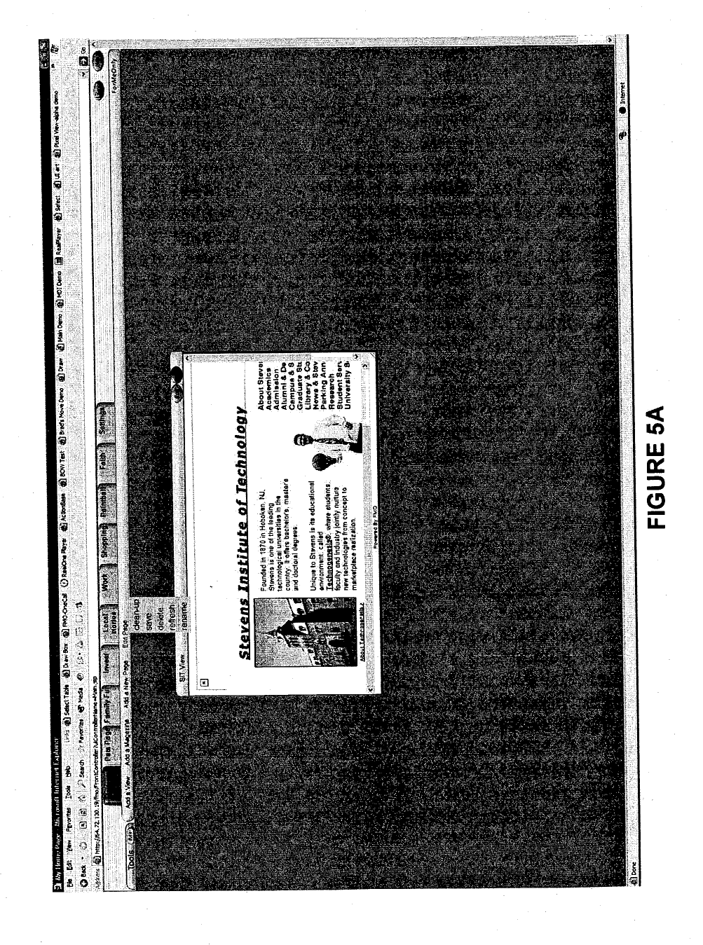

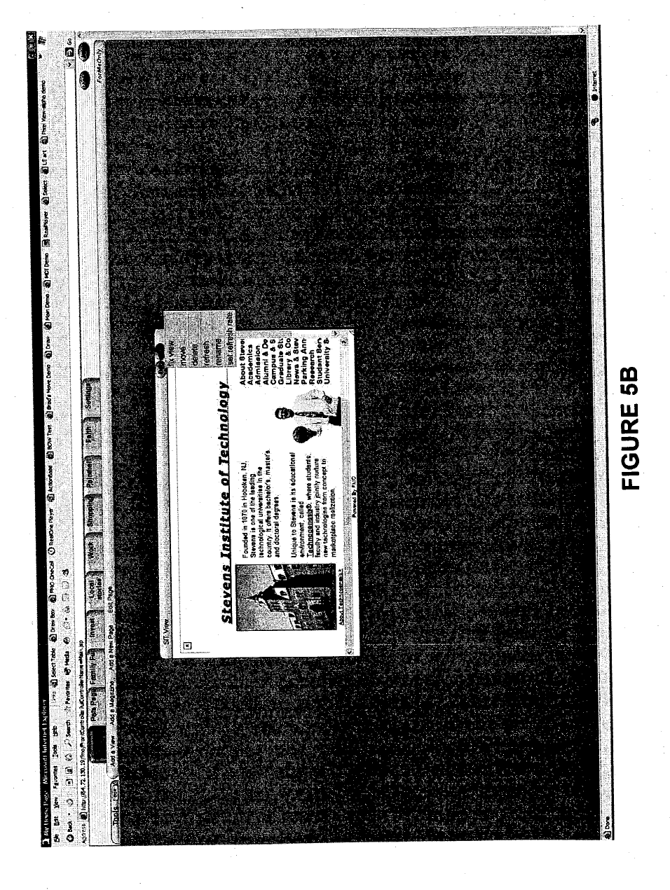

A sample magazine is shown in FIG. 4 in accordance with one embodiment of the present invention. Magazine 402 is list of headlines and links to corresponding articles stored at the life portal service provider servers and originally scraped from third-party web sites. The articles and content for a magazine are compiled from content scraped from web sites by the service provider. The various content are aggregated to form the text of the magazine articles.

Similarly, views are also unique to the user. A view, in contrast to a magazine, is from a single web site and shows content from only a selected web site. However, the user dictates what will be in the view and what content of the selected web site will comprise the view. In the described embodiment, there are two types of views: parsed views and pixel views.

Generally, a parsed view is content from a single table taken from a web page from a web site. Many web sites organize their data in web pages and tables. The life portal engine parses a web page into its separate tables. Generally, a pixel view results from retrieving an entire web page from a web site and allowing the user to display any segment of the page and does not involve parsing the web page or identifying tables in a web page.

A parsed view is created from parsing a web site into tables. As is known in the field of Internet application programming, web sites often use tables to delineate and format content on a web page. Many web sites use tables in this manner. A web page is parsed to separate the tables, each table containing a portion of content of the web site. The user selects which table will comprise the view. In the described embodiment, when selecting a table, a user moves a cursor over the tables after the page has been parsed and clicks on the table she wants. As the cursor moves over the tables, delimiters around the tables change indicating that the user is in a new table.

A pixel view is the entire web page offset behind what is visible via the portlet, in other words, a pixel view masks portions of the web page the user does not want to see. In creating a pixel view, the portal engine does not parse the web page. The entire page is loaded and configured such that the only content visible in the view is content that the user wants to see regardless of the table configuration on the web page. A pixel view is selected by a user by using a cursor to define an area on the web page that the user wants to be the view. The boxed area can be drawn anywhere on the page when defining a pixel view. Once the area has been defined, the content from the web page is placed in a portlet and becomes the view.

In the described embodiment, the user can choose whether a view is parsed or pixel. In another embodiment, the underlying structure of a view is determined by the life portal service provider. The fact that there are different types of views is visually transparent to the user. However, if content from a web site is displayed as a pixel view, an entire web page is transmitted to the life portal. Consequently, pixel views may cause unintentionally large volumes of data to be transmitted to the user's computer thereby consuming significant bandwidth and likely to cause processing slowdowns on the life portal. In contrast, parsed views result from creating content, i.e., a table, selected by the user.

Tables can be nested within other tables. In the described embodiment, the user selects tables by using a pointing device to highlight the desired tables after the service provider has parsed the HTML on a web page. For example, when a table is highlighted the background and text colors may be inverted, images may be shown in the negative, and a delimiter separating the parsed tables, such as a red line, dashes and blinks. The user then clicks on the selected table and the table becomes the view.

In the described embodiment, the Internet is used as the primary medium in which content and other data is transmitted and web sites as the primary content sources from which content is scraped and viewed on a life portal. It should be apparent that in other preferred embodiments of the invention, the content sources and medium are not limited to web sites and the Internet. Other forms of electronic data distribution could be used to gather information; information could be gathered from a variety of electronic sources other than web sites; and can be processed and displayed on via user interface and viewing tools other than Internet browsers (e.g., displays on hand held devices, smart devices, and the like). These preferred embodiments all fall within the scope of the present invention.

Although the foregoing invention has been described in some detail for purposes of clarity of understanding, it will be apparent that certain changes and modifications may be practiced within the scope of the appended claims. Furthermore, it should be noted that there are alternative ways of implementing both the process and apparatus of the present invention. For example, content may be fetched solely from third-party web sites rather than from the life service provider databases. In another example, the user may be presented with an empty life page or be queried by the service provider when initially creating a life portal. In yet another example, a parsed view may show a portion of a table or more than a single table. Accordingly, the present embodiments are to be considered as illustrative and not restrictive, and the invention is not to be limited to the details given herein, but may be modified within the scope and equivalents of the appended claims.

What we claim is:

1. A user life portal on the Internet built from the bottom up, comprising:
at least one life page;
at least one view contained within the at least one life page, wherein the at least one view is content relating to a user interest.

2. A user life portal as recited in claim 1 further comprising:
at least one magazine contained within the at least one life page wherein the at least one magazine is content in the form of headings and links to external content relating to a user interest.

3. A user life portal as recited in claim 1 wherein:
the at least one view is a pixel view created by displaying a portion of a web page selected by a life portal user.

4. A user life portal as recited in claim 2 wherein:
content is themed by a life portal service provider and used to compile the at least one magazine.

5. A user life portal as recited in claim 4 wherein:
content is clustered by a life portal service provider and used to compile the at least one magazine.

6. A user life portal as recited in claim 1 further comprising:
at least one first portlet for containing the at least one view.

7. A user life portal as recited in claim 2 further comprising:
at least one second portlet for containing the at least one magazine.

8. A user life portal as recited in claim 1 wherein:
the at least one view is a pre-created view created by a life portal service provider.

9. A user life portal as recited in claim 1 wherein:
content for the at least one view in the user life portal is scraped from a plurality of web sites on the Internet, wherein the plurality of web sites is not limited to a pre-determined set of web sites.

10. A user life portal as recited in claim 2 wherein:
content for the at least one magazine is scraped from a a plurality of web sites on the Internet, wherein the plurality of web sites is not limited to a pre-determined set of web sites.

11. A user life portal comprising:
a life page capable of containing a portlet capable of containing one of a view and a magazine relating to an interest of a user, wherein the life portal is created to meet a plurality of interests of the user.

12. A user life portal as recited in claim 11 wherein:
a plurality of views and a plurality of magazines can be viewed simultaneously in the life portal.

13. A user life portal as recited in claim 11 wherein:
the view is a pixel view such that content comprising the pixel view is any portion of an underlying web page.
